(19) United States
(12) Patent Application Publication
(10) Pub. No.: US 2024/0267215 A1
(43) Pub. Date: Aug. 8, 2024

(54) EQUIPMENT IDENTITY AUTHENTICATION METHOD AND APPARATUS, ELECTRONIC DEVICE, AND STORAGE MEDIUM

(71) Applicant: SUZHOU METABRAIN INTELLIGENT TECHNOLOGY CO., LTD., Suzhou, Jiangsu (CN)

(72) Inventor: Fuqiang MA, Suzhou, Jiangsu (CN)

(21) Appl. No.: 18/696,327

(22) PCT Filed: Sep. 27, 2022
(86) PCT No.: PCT/CN2022/121850

§ 371 Date: Mar. 27, 2024

(30) Foreign Application Priority Data
Nov. 18, 2021 (CN) 202111370808.5

(51) Int. Cl. H04L 9/08

(52) U.S. Cl. CPC H04L 9/088

(57) ABSTRACT

A method and an apparatus for authenticating a device identity, an electronic device and a storage medium are disclosed by the present application. In the present application, the trusted nodes of a tree-type hierarchical structure are constructed, and before a distributed operation is performed, an identity authentication operation is performed between the trusted node and the user device, which not only may enable the user device to perform distributed operations in the cloud computing platform, at the same time, the trusted node may be in a trusted environment to ensure that the operation content is available but invisible for the cloud computing platform, and confidentiality and integrity of the operation are protected.

### CROSS-REFERENCE TO RELATED APPLICATION

This application claims the priority of the Chinese Patent application filed on Nov. 18, 2021 before the China National Intellectual Property Administration with the application number of 202111370808.5, and the title of “EQUIPMENT IDENTITY AUTHENTICATION METHOD AND APPARATUS, ELECTRONIC DEVICE, AND STORAGE MEDIUM”, which is incorporated herein in its entirety by reference.

### FIELD

The present application relates to the technical field of cloud computing and, more particularly, to a method and an apparatus for authenticating a device identity, an electronic device and a storage medium.

### BACKGROUND

Security and trust are extremely important requirements in cloud computing. How to protect security of an application program and data hosted by a user on a cloud platform, to prevent a cloud service provider and another attacker from stealing confidential data of the user has always been a problem. A feasible solution is to implement a trusted execution environment (TEE for short) by using a confidential computing technology, so that the data is always kept in an encrypted and highly isolated state, thereby security and privacy of the data of the user is ensured.

In 2013, Intel proposed a new processor security technology software guard extensions (SGX) capable of providing a trusted execution environment in a user space on a computing platform, to ensure confidentiality and integrity of key code and data of the user. Since proposed, the SGX technology has become an important solution to solve a cloud computing security problem.

In the field of TEE researches, there has been a usability adaptation manner, for example, a library operating system LibOS and automatic program segmentation. For example, taking the SGX as an example, in the LibOS implementation solutions, classical Graphene, SCONE, Occlum, and the like are included.

Two types of identity authentication manners are proposed by the SGX: one is authentication between enclaves inside a platform, which is used to authenticate whether an enclave for reporting runs on a same platform with the enclave itself; and the other is remote authentication between platforms, which is used for a remote authenticator to authenticate identity information of an enclave.

In a distributed operating system (for example, MapReduce, a programming framework for a distributed operational program), remote identity authentication between every two nodes is required, to prove that the nodes are in a trusted execution environment of Occlum (a confidential computing operating system). A trusted channel is required to be established between every two nodes, which brings high communication traffic and a complex structure. At the same time, it takes long time to construct a trusted distributed operating system.

### SUMMARY

In order to solve the technical problem stated above or solve at least a part of the technical problem stated above, a method and an apparatus for authenticating a device identity, an electronic device and a storage medium are provided by the present application.

According to an aspect of the embodiments of the present application, a method for authenticating a device identity is provided, applied to a cloud computing platform, the method includes:
receiving an identity authentication request sent by a user device, wherein the identity authentication request is used to request for authentication of a trusted node set deployed in the cloud computing platform and configured to perform distributed computing, and the trusted node set includes a plurality of trusted nodes that are cascaded;
invoking each trusted node of the trusted node set to perform an authentication operation corresponding to the identity authentication request, to obtain an initial certification information tree corresponding to the trusted node set, wherein the initial certification information tree includes certification information corresponding to each trusted node;
sending the initial certification information tree to the user device, so that the user device performs re-authentication on the initial certification information tree; and
receiving a target certification information tree sent by the user device, and storing the target certification information tree to each trusted node, wherein the target certification information tree is obtained after the user device re-authenticates the initial certification information tree.

Further, the trusted node set includes a trusted root node, a trusted relay node and a trusted leaf node, the trusted root node is connected to at least two trusted relay nodes, and the trusted relay node is configured to be connected to at least two trusted leaf nodes; and
before invoking each trusted node of the trusted node set to perform the authentication operation corresponding to the identity authentication request, the method further includes:
establishing a first transmission channel between the user device and the trusted root node according to a preset key exchange protocol, and generating a first key;
establishing a second transmission channel between the trusted root node and the trusted relay node according to the preset key exchange protocol, and generating a second key; and
establishing a third transmission channel between the trusted relay node and the trusted leaf node according to the preset key exchange protocol, and generating a third key.

Further, invoking each trusted node of the trusted node set to perform the authentication operation corresponding to the identity authentication request, to obtain the initial certification information tree corresponding to the trusted node set includes:
issuing the identity authentication request to the trusted relay node and the trusted leaf node through the trusted root node;
performing, by the trusted leaf node, a first authentication operation based on the identity authentication request, to obtain first authentication information corresponding to the trusted leaf node, encrypting the first authentication information by using the third key, and sending the encrypted first authentication information to the trusted relay node through the third transmission channel;
decrypting, by the trusted relay node, the first authentication information encrypted by all trusted leaf nodes, sending the decrypted first authentication information to a certification center for certification to obtain a first certification result, and generating a first certification information tree based on the first certification result;
performing, by the trusted relay node, a second authentication operation based on the identity authentication request, to obtain second authentication information corresponding to the trusted relay node;
encrypting, by the trusted relay node, the second authentication information and the first certification information tree by using the second key, and sending the second authentication information and the first certification information tree that are encrypted to the trusted root node through the second transmission channel;
decrypting, by the trusted root node, the second authentication information and the first certification information trees that are encrypted by all trusted relay nodes, sending the decrypted second authentication information to the certification center to obtain a second certification result, and generating a second certification information tree based on the second certification result and the first certification information trees; and
performing, by the trusted root node, a third authentication operation based on the identity authentication request, to obtain third authentication information corresponding to the trusted root node, adding the third authentication information to the second certification information tree to obtain the initial certification information tree, encrypting the initial certification information tree by using the first key, and sending the encrypted initial certification information tree to the user device.

Further, performing, by the trusted leaf node, the first authentication operation based on the identity authentication request, to obtain the first authentication information corresponding to the trusted leaf node includes:
generating, by the trusted leaf node, a first authentication code by using a symmetric key of a quoting enclave, and sending the first authentication code to the quoting enclave, so that the quoting enclave verifies the first authentication code;
receiving, by the trusted leaf node, a first quoting structure body and a first signature that are fed back by the quoting enclave, wherein the first quoting structure body and the first signature are obtained after the quoting enclave successfully verifies the first authentication code; and
determining the first quoting structure body and the first signature as the first authentication information.

Further, performing, by the trusted relay node, the second authentication operation based on the identity authentication request, to obtain the second authentication information corresponding to the trusted relay node includes:
sending, by the trusted relay node, a first certification request to a third-party certification device to obtain the first certification result, wherein the first certification request is used to certify the first authentication information of the trusted leaf node;
in response to, based on the first certification result, the first authentication information of the trusted leaf node passing certification, generating, by the trusted relay node, a second authentication code by using a symmetric key of a quoting enclave, and sending the second authentication code and the first certification information tree to the quoting enclave, so that the quoting enclave verifies the second authentication code;
receiving, by the trusted relay node, a second quoting structure body and a second signature that are fed back by the quoting enclave, wherein the second quoting structure body and the second signature are obtained after the quoting enclave successfully verifies the second authentication code; and
determining the second quoting structure body and the second signature as the second authentication information.

Further, performing, by the trusted root node, the third authentication operation based on the identity authentication request, to obtain the third authentication information corresponding to the trusted root node includes:
sending, by the trusted root node, a second certification request to a third-party certification device to obtain the second certification result, wherein the second certification request is used to certify the second authentication information of the trusted relay node;
in response to, based on the second certification result, the second authentication information of the trusted relay node passing certification, generating, by the trusted root node, a third authentication code by using a symmetric key of a quoting enclave, and sending the third authentication code and the second certification information tree to the quoting enclave, so that the quoting enclave verifies the third authentication code;
receiving, by the trusted root node, a third quoting structure body and a third signature that are fed back by the quoting enclave, wherein the third quoting structure body and the third signature are obtained after the quoting enclave successfully verifies the third authentication code; and
determining the third quoting structure body and the third signature as the third authentication information.

Further, after receiving the target certification information tree sent by the user device, and storing the target certification information tree to each trusted node, the method further includes:
receiving a distributed computing request sent by the user device, wherein the distributed computing request carries target data sent by the user device and a distribution manner corresponding to the target data;
sending, by using the trusted root node, the target data to the trusted relay node according to the distribution manner, and sending, by the trusted relay node, the target data to the trusted leaf node according to the distribution manner;
performing, by the trusted leaf node, the distributed computing on the target data to obtain a first computing result, and sending the first computing result to the trusted relay node;
summarizing, by the trusted relay node, the first computing result to obtain a second computing result, and sending the second computing result to the trusted root node; and
summarizing, by the trusted root node, the second computing result to obtain a third computing result, and sending the third computing result to the user device.

According to another aspect of the embodiments of the present application, an apparatus for authenticating a device identity is further provided, wherein the apparatus includes:
a receiving module, configured to receive an identity authentication request sent by a user device, wherein the identity authentication request is used to request for authentication of a trusted node set deployed in a cloud computing platform and configured to perform distributed computing, and the trusted node set includes a plurality of trusted nodes that are cascaded;
an invoking module, configured to invoke each trusted node of the trusted node set to perform an authentication operation corresponding to the identity authentication request, to obtain an initial certification information tree corresponding to the trusted node set, wherein the initial certification information tree includes certification information corresponding to each trusted node;
a sending module, configured to send the initial certification information tree to the user device, so that the user device performs re-authentication on the initial certification information tree; and
a storage module, configured to receive a target certification information tree sent by the user device, and store the target certification information tree to each trusted node, wherein the target certification information tree is obtained after the user device re-authenticates the initial certification information tree.

According to another aspect of the embodiments of the present application, a non-transitory readable storage medium is further provided, wherein the non-transitory readable storage medium includes a stored program, and when the stored program runs, the steps of the method stated above are executed.

According to another aspect of the embodiments of the present application, an electronic device is further provided, which includes a processor, a communication interface, a memory, and a communication bus, wherein the processor, the communication interface, and the memory communicate with each other through the communication bus; the memory is configured to store a computer program; and the processor is configured to run the computer program stored on the memory to execute the steps of the method stated above.

A computer program product including an instruction is further provided in the embodiments of the present application, when the computer program product runs on a computer, the computer is caused to execute the steps of the method stated above.

Compared with the prior art, the technical solutions provided in the embodiments of the present application have the following advantages: in the present application, the trusted nodes of a tree-type hierarchical structure are constructed, and before a distributed operation is performed, an identity authentication operation is performed between the trusted node and the user device, which not only may enable the user device to perform distributed operations in the cloud computing platform, at the same time, the trusted node may be in a trusted environment to ensure that the operation content is available but invisible for the cloud computing platform, and confidentiality and integrity of the operation are protected.

### BRIEF DESCRIPTION OF THE DRAWINGS

The drawings here are incorporated into the description and form a part of the description. The drawings show the embodiments that comply with the present disclosure, and are used to interpret the principle of the present disclosure together with the description.

In order to more clearly illustrate the technical solutions of the embodiments of the present disclosure or the prior art, the figures that are required to be used to describe the embodiments or the prior art may be briefly described below. Apparently, a person skilled in the art may obtain other figures according to these figures without paying creative work.

FIG. 1 is a flowchart of a method for authenticating a device identity according to an embodiment of the present application;

FIG. 2 is a schematic diagram of an identity authentication framework according to an embodiment of the present application;

FIG. 3 is a flowchart of a method for authenticating a device identity according to another embodiment of the present application;

FIG. 4 is a flowchart of a method for authenticating a device identity according to another embodiment of the present application;

FIG. 5 is a flowchart of a method for authenticating a device identity according to another embodiment of the present application;

FIG. 6 is a block diagram of an apparatus for authenticating a device identity according to an embodiment of the present application; and

FIG. 7 is a schematic diagram of a structure of an electronic device according to an embodiment of the present application.

### DETAILED DESCRIPTION

In order to make the objects, the technical solutions and the advantages of the embodiments of the present disclosure clearer, the technical solutions in the embodiments of the present disclosure may be clearly and completely described below with reference to the drawings in the embodiments of the present disclosure. Apparently, the described embodiments are merely certain embodiments of the present disclosure, rather than all of the embodiments. The illustrative embodiments of the present disclosure and their explanation are intended to interpret the present disclosure, and do not constitute an inappropriate limitation to the present disclosure. All of the other embodiments that a person skilled in the art obtains on the basis of the embodiments of the present disclosure without paying creative work fall within the protection scope of the present disclosure.

It should be noted that, in the present text, relation terms such as “first” and “second” are merely intended to distinguish one entity or operation from another similar entity or operation, and that does not necessarily require or imply that there are any such actual relation or order between those entities or operations. Furthermore, the terms “include”, “contain” or any variants thereof are intended to cover non-exclusive inclusions, so that processes, methods, articles or devices that include a series of elements do not only include those elements, but also include other elements that are not explicitly listed, or include the elements that are inherent to such processes, methods, articles or devices. Without more limitation, an element defined by the wording “including a . . . ” does not exclude additional same element existing in the process, method, article or device including the element.

A method and an apparatus for authenticating a device identity, an electronic device and a storage medium are provided by the embodiments of the present application. The method provided by the embodiments of the present application may be applied to any required electronic device, for example, a server or a terminal, which is not limited herein. For ease of description, the required electronic device is referred to as an electronic device hereinafter.

According to an aspect of the embodiments of the present application, a method embodiment of a method for authenticating a device identity is provided.

FIG. 1 is a flowchart of a method for authenticating a device identity according to an embodiment of the present application. As shown in FIG. 1, the method includes the following steps.

Step S11, receiving an identity authentication request sent by a user device, wherein the identity authentication request is used to request for authentication of a trusted node set deployed in a cloud computing platform and configured to perform distributed computing, and the trusted node set includes a plurality of trusted nodes that are cascaded.

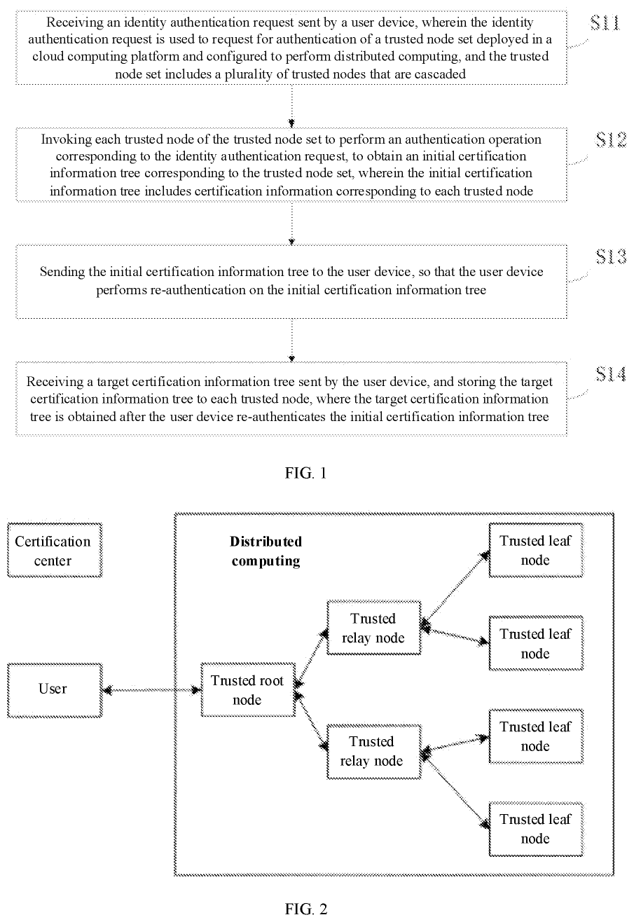

In an embodiment of the present application, when the user device performs a distributed computing service, the user device may send the identity authentication request to the cloud computing platform. The cloud computing platform includes the trusted node set configured to perform distributed computing. The trusted node set includes the plurality of trusted nodes that are cascaded. As shown in FIG. 2, the plurality of trusted nodes that are cascaded are a trusted root node, trusted relay nodes, and trusted leaf nodes. The trusted root node is connected to at least two trusted relay nodes. The trusted relay node is configured to be connected to at least two trusted leaf nodes.

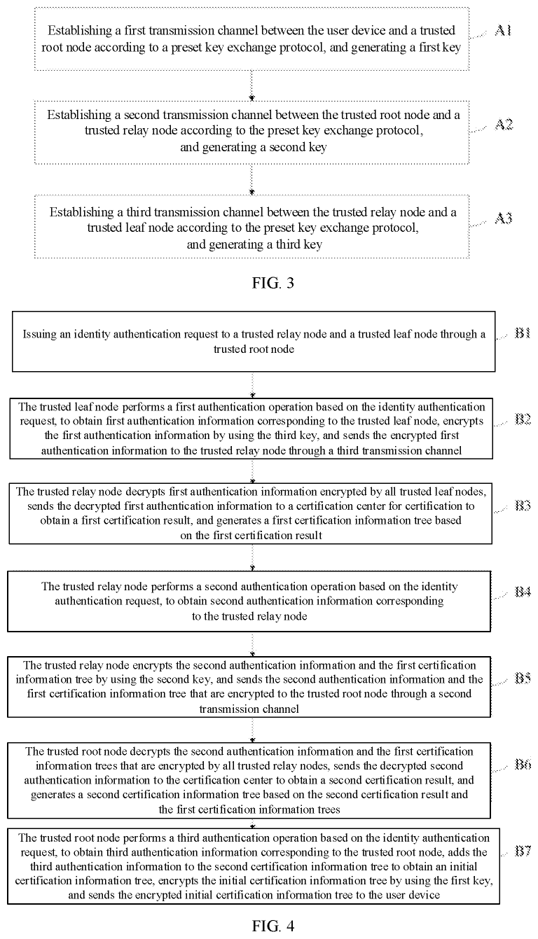

In an embodiment of the present application, before each trusted node of the trusted node set is invoked to perform the authentication operation corresponding to the identity authentication request, signal transmission is established between the cloud computing platform and the user device, and a transmission channel is established between nodes inside the cloud computing platform. As shown in FIG. 3, the method further includes the following steps A1 to A3.

Step A1, establishing a first transmission channel between the user device and a trusted root node according to a preset key exchange protocol, and generating a first key.

Step A2, establishing a second transmission channel between the trusted root node and a trusted relay node according to the preset key exchange protocol, and generating a second key.

Step A3, establishing a third transmission channel between the trusted relay node and a trusted leaf node according to the preset key exchange protocol, and generating a third key.

Step S12, invoking each trusted node of the trusted node set to perform an authentication operation corresponding to the identity authentication request, to obtain an initial certification information tree corresponding to the trusted node set, wherein the initial certification information tree includes certification information corresponding to each trusted node.

In an embodiment of the present application, the step S12 of invoking each trusted node of the trusted node set to perform the authentication operation corresponding to the identity authentication request, to obtain the initial certification information tree corresponding to the trusted node set, as shown in FIG. 4, includes the following steps B1 to B5.

Step B1, issuing an identity authentication request to a trusted relay node and a trusted leaf node through a trusted root node.

Step B2, the trusted leaf node performs a first authentication operation based on the identity authentication request, to obtain first authentication information corresponding to the trusted leaf node, encrypts the first authentication information by using the third key, and sends the encrypted first authentication information to the trusted relay node through a third transmission channel.

In an embodiment of the present application, that the trusted leaf node performs the first authentication operation based on the identity authentication request, to obtain the first authentication information corresponding to the trusted leaf node in step B2 includes the following steps B201 to B203.

Step B201, the trusted leaf node generates a first authentication code by using a symmetric key of a quoting enclave, and sends the first authentication code to the quoting enclave, so that the quoting enclave verifies the first authentication code.

Step B202, the trusted leaf node receives a first quoting structure body and a first signature that are fed back by the quoting enclave, wherein the first quoting structure body and the first signature are obtained after the quoting enclave successfully verifies the first authentication code.

Step B203, the first quoting structure body and the first signature are determined as the first authentication information.

In an embodiment of the present application, the trusted leaf node executes the identity authentication request, and combines an identity of the trusted leaf node and additional information to generate a report structure. The trusted leaf node generates a media access control (MAC) address (which may be referred to as a physical address, a local area 30) network address, or an Ethernet address) by using a report symmetric key of the quoting enclave. The trusted leaf node sends the report structure and the MAC address to the quoting enclave. The quoting enclave verifies, by using the report symmetric key of the quoting enclave, whether the trusted leaf node runs on a same cloud computing platform, then is encapsulated into a quoting structure body QUOTE (the first quoting structure body), performs signing (the first signature) by using a private key of the corresponding trusted leaf node registered in a third-party trusted certification center, and determines the first quoting structure body and the first signature as the first authentication information.

Step B3, the trusted relay node decrypts the first authentication information encrypted by all trusted leaf nodes, sends the decrypted first authentication information to a certification center for certification to obtain a first certification result, and generates a first certification information tree based on the first certification result.

Step B4, the trusted relay node performs a second authentication operation based on the identity authentication request, to obtain second authentication information corresponding to the trusted relay node.

In an embodiment of the present application, that the trusted relay node performs the second authentication operation based on the identity authentication request, to obtain the second authentication information corresponding to the trusted relay node in step B4 includes the following steps B401 to B404.

Step B401, the trusted relay node sends a first certification request to a third-party certification device to obtain the first certification result, wherein the first certification request is used to certify the first authentication information of the trusted leaf node.

Step B402, when it is determined, based on the first certification result, that the first authentication information of the trusted leaf node passes certification, the trusted relay node generates a second authentication code by using a symmetric key of a quoting enclave, and sends the second authentication code and the first certification information tree to the quoting enclave, so that the quoting enclave verifies the second authentication code.

Step B403, the trusted relay node receives a second quoting structure body and a second signature that are fed back by the quoting enclave, wherein the second quoting structure body and the second signature are obtained after the quoting enclave successfully verifies the second authentication code.

Step B404, the second quoting structure body and the second signature are determined as the second authentication information.

In an embodiment of the present application, the trusted relay node verifies an identity of the trusted leaf node through the third-party trusted certification center, and generates corresponding trusted leaf node certification information. The trusted relay node constructs a remote certification hash tree (hash tree), adds certification information corresponding to all trusted leaf nodes connected to the trusted relay node to the remote certification hash tree, and computes a trusted leaf node certification information hash tree.

The trusted relay node executes an EREPORT instruction, and combines an identity of the trusted relay node and additional information to generate a report structure. The trusted relay node generates a MAC address by using a report symmetric key of the quoting enclave. The trusted relay node sends the report structure and the MAC address to the quoting enclave. The quoting enclave verifies, by using the report symmetric key of the quoting enclave, whether the trusted relay node runs on the same platform, then is encapsulated into a quoting structure body QUOTE (the second quoting structure body), adds the remote certification hash tree to the quoting structure body QUOTE as user data, performs signing (the second signature) by using a private key of the corresponding trusted relay node registered in the third-party trusted certification center, and determines the second quoting structure body and the second signature as the second authentication information.

Then, the trusted relay node encrypts the second authentication information by using the second key, and sends the encrypted authentication information to the trusted root node through the second transmission channel.

Step B5, the trusted relay node encrypts the second authentication information and the first certification information tree by using the second key, and sends the second authentication information and the first certification information tree that are encrypted to the trusted root node through a second transmission channel.

Step B6, the trusted root node decrypts the second authentication information and the first certification information trees that are encrypted by all trusted relay nodes, sends the decrypted second authentication information to the certification center to obtain a second certification result, and generates a second certification information tree based on the second certification result and the first certification information trees.

Step B7, the trusted root node performs a third authentication operation based on the identity authentication request, to obtain third authentication information corresponding to the trusted root node, adds the third authentication information to the second certification information tree to obtain an initial certification information tree, encrypts the initial certification information tree by using the first key, and sends the encrypted initial certification information tree to the user device.

In an embodiment of the present application, that the trusted root node performs the third authentication operation based on the identity authentication request, to obtain the third authentication information corresponding to the trusted root node in step B7 includes the following steps B701 to B704.

Step B701, the trusted root node sends a second certification request to the third-party certification device to obtain the second certification result, wherein the second certification request is used to certify the second authentication information of the trusted relay node.

Step B702, when it is determined, based on the second certification result, that the second authentication information of the trusted relay node passes certification, the trusted root node generates a third authentication code by using a symmetric key of a quoting enclave, and sends the third authentication code and the second certification information tree to the quoting enclave, so that the quoting enclave verifies the third authentication code.

Step B703, the trusted root node receives a third quoting structure body and a third signature that are fed back by the quoting enclave, wherein the third quoting structure body and the third signature are obtained after the quoting enclave successfully verifies the third authentication code.

Step B704, the third quoting structure body and the third signature are determined as the third authentication information.

In an embodiment of the present application, the trusted root node adds the certification information corresponding to all trusted relay nodes connected to the trusted root node to a remote certification hash tree, and generates a trusted relay node certification information hash tree. The trusted root node executes an EREPORT instruction, and combines an identity of the trusted root node and additional information to generate a report structure.

The trusted root node generates a MAC address by using a report symmetric key of the quoting enclave. The trusted root node sends the report structure and the MAC address to the quoting enclave. The quoting enclave verifies, by using the report symmetric key of the quoting enclave, whether the trusted root node runs on the same platform, then is encapsulated into a quoting structure body QUOTE (the third quoting structure body), adds the remote certification hash tree to the quoting structure body QUOTE as user data, performs signing (the third signature) by using a private key of the corresponding trusted root node registered in a third-party trusted certification center, and determines the third quoting structure body and the third signature as the third authentication information.

Then, the trusted root node encrypts the third authentication information by using the first key, and sends the encrypted authentication information to the trusted root node through the first transmission channel.

Step S13, sending the initial certification information tree to the user device, so that the user device performs re-authentication on the initial certification information tree.

In an embodiment of the present application, the user device verifies an identity of the trusted root node through the third-party trusted certification center, and generates corresponding trusted root node certification information. The user adds the trusted root node certification information to the remote certification hash tree, and computes a certification information hash tree. The user sends the remote certification hash tree to the trusted root node, the trusted relay node, and the trusted leaf node in a distributed operation system.

Step S14, receiving a target certification information tree sent by the user device, and storing the target certification information tree to each trusted node, wherein the target certification information tree is obtained after the user device re-authenticates the initial certification information tree.

In the present application, the trusted nodes of a tree-type hierarchical structure are constructed, and before a distributed operation is performed, an identity authentication operation is performed between the trusted node and the user device, which not only may enable the user device to perform distributed operations in the cloud computing platform, at the same time, the trusted node may be in a trusted environment to ensure that the operation content is available but invisible for the cloud computing platform, and confidentiality and integrity of the operation are protected.

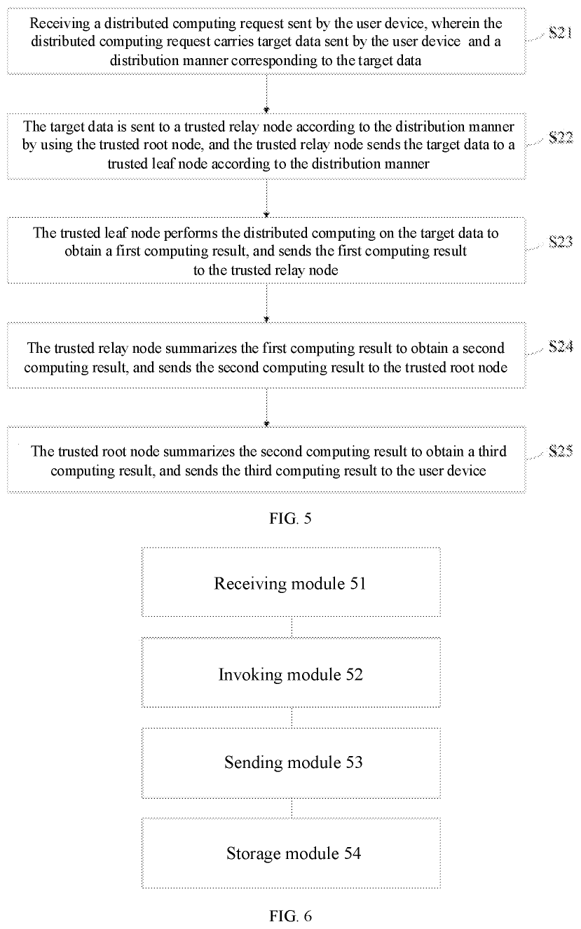

In an embodiment of the present application, after the target certification information tree sent by the user device is received, and the target certification information tree is stored to trusted nodes, as shown in FIG. 5, the method further includes the following steps.

Step S21, receiving a distributed computing request sent by the user device, wherein the distributed computing request carries target data sent by the user device and a distribution manner corresponding to the target data.

Step S22, the target data is sent to a trusted relay node according to the distribution manner by using the trusted root node, and the trusted relay node sends the target data to a trusted leaf node according to the distribution manner.

Step S23, the trusted leaf node performs the distributed computing on the target data to obtain a first computing result, and sends the first computing result to the trusted relay node.

Step S24, the trusted relay node summarizes the first computing result to obtain a second computing result, and sends the second computing result to the trusted root node.

Step S25, the trusted root node summarizes the second computing result to obtain a third computing result, and sends the third computing result to the user device.

In an embodiment of the present application, the user device generates a temporary key, encrypts data and a key code by using the temporary key, encrypts the temporary key by using the first key, and then sends the encrypted temporary key to the trusted root node. The trusted root node distributes the encrypted data to the trusted relay node according to the data distribution manner specified by the user device.

The trusted root node sends the encrypted key code to the trusted relay node. The trusted root node decrypts the temporary key by using the first key, encrypts the temporary key by using the second key, and distributes the encrypted temporary key to the trusted relay node.

The trusted relay node distributes the encrypted data to the trusted leaf node according to the data distribution manner specified by the user device. The trusted relay node sends the encrypted key code to the trusted leaf node. The trusted relay node decrypts the temporary key by using the second key, encrypts the temporary key by using the third key, and then distributes the encrypted temporary key to the trusted leaf node.

The trusted leaf node decrypts the temporary key by using the third key corresponding to the trusted leaf node itself, and decrypts data and a key code by using the temporary key. The trusted leaf node performs a distributed operation on the data based on the key code, and generates a corresponding result. The result is encrypted by using the third key, and the encrypted result is sent to the trusted relay node. The trusted relay node performs decryption by using the third key, performs a summarization operation on an operation result, and encrypts a summarization result by using the second key and sends to the trusted root node. The trusted root node decrypts the operation result of the trusted relay node by using the second key, performs a summarization operation on the operation result, and encrypts the summarization result by using the first key and sends to the user device. The user device performs decryption by using the first key, to obtain a final distributed operation result.

FIG. 6 is a block diagram of an apparatus for authenticating a device identity according to an embodiment of the present application. The apparatus may be implemented into a part or all of an electronic device through software, hardware, or a combination thereof. As shown in FIG. 6, the apparatus includes:
a receiving module 51, configured to receive an identity authentication request sent by a user device, wherein the identity authentication request is used to request for authentication of a trusted node set deployed in the cloud computing platform and configured to perform distributed computing, and the trusted node set includes a plurality of trusted nodes that are cascaded;
an invoking module 52, configured to invoke each trusted node of the trusted node set to perform an authentication operation corresponding to the identity authentication request, to obtain an initial certification information tree corresponding to the trusted node set, wherein the initial certification information tree includes certification information corresponding to each trusted node;
a sending module 53, configured to send the initial certification information tree to the user device, so that the user device performs re-authentication on the initial certification information tree; and
a storage module 54, configured to receive a target certification information tree sent by the user device, and store the target certification information tree to each trusted node, wherein the target certification information tree is obtained after the user device re-authenticates the initial certification information tree.

In an embodiment of the present application, the trusted node set includes a trusted root node, a trusted relay node, and a trusted leaf node. The trusted root node is connected to at least two trusted relay nodes. The trusted relay node is configured to be connected to at least two trusted leaf nodes.

In an embodiment of the present application, the apparatus for authenticating the device identity further includes a construction module, configured to: establish a first transmission channel between the user device and the trusted root node according to a preset key exchange protocol, and generate a first key; establish a second transmission channel between the trusted root node and the trusted relay node according to the preset key exchange protocol, and generate a second key; and establish a third transmission channel between the trusted relay node and the trusted leaf node according to the preset key exchange protocol, and generate a third key.

In an embodiment of the present application, the invoking module 52 includes:
a sending sub-module, configured to issue the identity authentication request to the trusted relay node and the trusted leaf node through the trusted root node;
a first execution sub-module, configured to: perform, by the trusted leaf node, a first authentication operation based on the identity authentication request, to obtain first authentication information corresponding to the trusted leaf node, encrypt the first authentication information by using the third key, and send the encrypted first authentication information to the trusted relay node through the third transmission channel;
a first processing sub-module, configured to: decrypt, by the trusted relay node, the first authentication information encrypted by all trusted leaf nodes, send the decrypted first authentication information to a certification center for certification to obtain a first certification result, and generate a first certification information tree based on the first certification result;
a second execution sub-module, configured to perform, by the trusted relay node, a second authentication operation based on the identity authentication request, to obtain second authentication information corresponding to the trusted relay node;
a second processing sub-module, configured to: encrypt, by the trusted relay node, the second authentication information and the first certification information tree by using the second key, and send the second authentication information and the first certification information tree that are encrypted to the trusted root node through the second transmission channel;
a third execution sub-module, configured to: decrypt, by the trusted root node, the second authentication information and the first certification information trees that are encrypted by all trusted relay nodes, send the decrypted second authentication information to the certification center to obtain a second certification result, and generate a second certification information tree based on the second certification result and the first certification information trees; and
a fourth execution sub-module, configured to: perform, by the trusted root node, a third authentication operation based on the identity authentication request, to obtain third authentication information corresponding to the trusted root node, add the third authentication information to the second certification information tree to obtain the initial certification information tree, encrypt the initial certification information tree by using the first key, and send the encrypted initial certification information tree to the user device.

In an embodiment of the present application, the first execution sub-module is configured to: generate, by the trusted leaf node, a first authentication code by using a symmetric key of a quoting enclave, and send the first authentication code to the quoting enclave, so that the quoting enclave verifies the first authentication code; receive, by the trusted leaf node, a first quoting structure body and a first signature that are fed back by the quoting enclave, wherein the first quoting structure body and the first signature are obtained after the quoting enclave successfully verifies the first authentication code; and determine the first quoting structure body and the first signature as the first authentication information.

In an embodiment of the present application, the second execution sub-module is configured to: send, by the trusted relay node, a first certification request to a third-party certification device to obtain the first certification result, wherein the first certification request is used to certify the first authentication information of the trusted leaf node; when it is determined, based on the first certification result, that the first authentication information corresponding to the trusted leaf node passes certification, generate, by the trusted relay node, a second authentication code by using a symmetric key of a quoting enclave, and send the second authentication code and the first certification information tree to the quoting enclave, so that the quoting enclave verifies the second authentication code; receive, by the trusted relay node, a second quoting structure body and a second signature that are fed back by the quoting enclave, wherein the second quoting structure body and the second signature are obtained after the quoting enclave successfully verifies the second authentication code; and determine the second quoting structure body and the second signature as the second authentication information.

In an embodiment of the present application, the third execution sub-module is configured to: send, by the trusted root node, a second certification request to a third-party certification device to obtain the second certification result, wherein the second certification request is used to certify the second authentication information of the trusted relay node; when it is determined, based on the second certification result, that the second authentication information of the trusted relay node passes certification, generate, by the trusted root node, a third authentication code by using the symmetric key of the quoting enclave, and send the third authentication code and the second certification information tree to the quoting enclave, so that the quoting enclave verifies the third authentication code; receive, by the trusted root node, a third quoting structure body and a third signature that are fed back by the quoting enclave, wherein the third quoting structure body and the third signature are obtained after the quoting enclave successfully verifies the third authentication code; and determine the third quoting structure body and the third signature as the third authentication information.

In an embodiment of the present application, the apparatus for authenticating the device identity further includes: a computing module, configured to: receive a distributed computing request sent by the user device, wherein the distributed computing request carries target data sent by the user device and a distribution manner corresponding to the target data; send, by using the trusted root node, the target data to the trusted relay node according to the distribution manner, and send, by the trusted relay node, the target data to the trusted leaf node according to the distribution manner; perform, by the trusted leaf node, distributed computing on the target data to obtain a first computing result, and send the first computing result to the trusted relay node; summarize, by the trusted relay node, the first computing result to obtain a second computing result, and send the second computing result to the trusted root node; and summarize, by the trusted root node, the second computing result to obtain a third computing result, and send the third computing result to the user device.

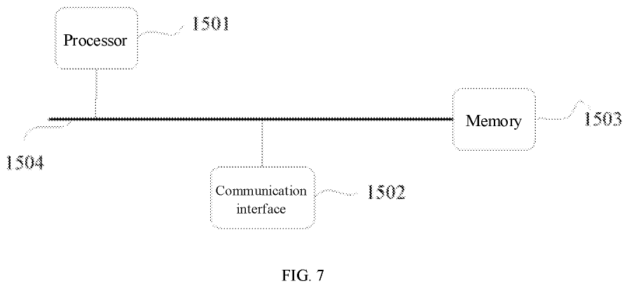

An electronic device is further provided by an embodiment of the present application. As shown in FIG. 7, the electronic device may include a processor 1501, a communication interface 1502, a memory 1503, and a communication bus 1504. The processor 1501, the communication interface 1502, and the memory 1503 communicate with each other through the communication bus 1504.

The memory 1503 is configured to store a computer program.

The processor 1501 is configured to when the computer program stored on the memory 1503 is executed, the steps in the foregoing embodiments are implemented.

The communication bus mentioned in the foregoing terminal may be a peripheral component interconnect (PCI for short) bus, an extended industry standard architecture (EISA for short) bus, or the like. The communication bus may be categorized as an address bus, a data bus, a control bus, or the like. For ease of representation, only one thick line is used to represent the bus in the figure, but this does not mean that there is only one bus or only one type of bus.

The communication interface is configured to implement communication between the electronic device and another device.

The memory may include a random access memory (RAM for short), or may include a non-transitory memory, for example, at least one disk storage. Alternatively, the memory may be at least one storage apparatus far away from the processor.

The processor stated above may be a general-purpose processor, including a central processing unit (CPU for short), a network processor (NP for short), and the like, or may be a digital signal processor (DSP for short), an application specific-integrated circuit (ASIC for short), a field-programmable gate array (FPGA for short) or another programmable logic device, a discrete gate or transistor logic device, or a discrete hardware component.

In still another embodiment provided in the present application, a non-transitory readable storage medium is further provided. The non-transitory readable storage medium stores instructions. When the instructions run on a computer, the computer is caused to perform the method for authenticating the device identity in any one of the foregoing embodiments.

In still another embodiment provided in the present application, a computer program product including instructions is further provided. When the computer program product runs on a computer, the computer is caused to perform the method for authenticating the device identity in any one of the foregoing embodiments.

All or some of the foregoing embodiments may be implemented by software, hardware, firmware, or any combination thereof. When the software is used to implement the embodiments, all or some of the embodiments may be implemented in a form of a computer program product. The computer program product includes one or more computer instructions. When the computer program instructions are loaded and executed on a computer, all or some of the processes or functions according to the embodiments of the present application are 10) generated. The computer may be a general-purpose computer, a dedicated computer, a computer network, or another programmable apparatus. The computer instructions may be stored in a non-transitory readable storage medium, or may be transmitted from a non-transitory readable storage medium to another non-transitory readable storage medium. For example, the computer instructions may be transmitted from a website, computer, server, or data center to another website, computer, server, or data center in a wired (for example, a coaxial cable, an optical fiber, or a digital subscriber line) or wireless (for example, infrared, radio, and microwave, or the like) manner. The non-transitory readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state disk), or the like.

The above is merely the example of the embodiments of the present application and not intended to limit the protection scope of the present application. Any modification, equivalent replacement, and improvement made within the spirit and principle of the present application shall fall within the protection scope of the present application.

The above is only the specific embodiment of the present application, so that a person skilled in the art may understand or realize the present application. Various modifications to these embodiments may be obvious to a person skilled in the art. The general principles defined herein may be implemented in other embodiments without departing from the spirit or scope of the present application. Therefore, the present application should not be limited to these embodiments shown in the present application, but should conform to the widest range consistent with the principles and novel features applied in the present application.

1. A method for authenticating a device identity, applied to a cloud computing platform, comprising:
receiving an identity authentication request sent by a user device, wherein the identity authentication request is used to request for authentication of a trusted node set deployed in the cloud computing platform and configured to perform distributed computing, and the trusted node set comprises a plurality of trusted nodes that are cascaded;
invoking each trusted node of the trusted node set to perform an authentication operation corresponding to the identity authentication request, to obtain an initial certification information tree corresponding to the trusted node set, wherein the initial certification information tree comprises certification information corresponding to each trusted node;
sending the initial certification information tree to the user device, so that the user device performs re-authentication on the initial certification information tree; and
receiving a target certification information tree sent by the user device, and storing the target certification information tree to each trusted node, wherein the target certification information tree is obtained after the user device re-authenticates the initial certification information tree.

2. The method according to claim 1, wherein the trusted node set comprises a trusted root node, a trusted relay node and a trusted leaf node, the trusted root node is connected to at least two trusted relay nodes, and the trusted relay node is configured to be connected to at least two trusted leaf nodes; and
before invoking each trusted node of the trusted node set to perform the authentication operation corresponding to the identity authentication request, the method further comprises:
establishing a first transmission channel between the user device and the trusted root node according to a preset key exchange protocol, and generating a first key;
establishing a second transmission channel between the trusted root node and the trusted relay node according to the preset key exchange protocol, and generating a second key; and
establishing a third transmission channel between the trusted relay node and the trusted leaf node according to the preset key exchange protocol, and generating a third key.

3. The method according to claim 2, wherein receiving the target certification information tree sent by the user device, and storing the target certification information tree to each trusted node comprises:
receiving the target certification information tree sent by the user device, and sending the target certification information tree to the trusted root node, the trusted relay node, and the trusted leaf node that are configured to perform the distributed computing.

4. The method according to claim 2, wherein invoking each trusted node of the trusted node set to perform the authentication operation corresponding to the identity authentication request, to obtain the initial certification information tree corresponding to the trusted node set comprises:
issuing the identity authentication request to the trusted relay node and the trusted leaf node through the trusted root node;
performing, by the trusted leaf node, a first authentication operation based on the identity authentication request, to obtain first authentication information corresponding to the trusted leaf node, encrypting the first authentication information by using the third key, and sending the encrypted first authentication information to the trusted relay node through the third transmission channel;
decrypting, by the trusted relay node, the first authentication information encrypted by all trusted leaf nodes, sending the decrypted first authentication information to a certification center for certification to obtain a first certification result, and generating a first certification information tree based on the first certification result;
performing, by the trusted relay node, a second authentication operation based on the identity authentication request, to obtain second authentication information corresponding to the trusted relay node;
encrypting, by the trusted relay node, the second authentication information and the first certification information tree by using the second key, and sending the second authentication information and the first certification information tree that are encrypted to the trusted root node through the second transmission channel;
decrypting, by the trusted root node, the second authentication information and the first certification information trees that are encrypted by all trusted relay nodes, sending the decrypted second authentication information to the certification center to obtain a second certification result, and generating a second certification information tree based on the second certification result and the first certification information trees; and
performing, by the trusted root node, a third authentication operation based on the identity authentication request, to obtain third authentication information corresponding to the trusted root node, adding the third authentication information to the second certification information tree to obtain the initial certification information tree, encrypting the initial certification information tree by using the first key, and sending the encrypted initial certification information tree to the user device.

5. The method according to claim 4, wherein performing, by the trusted leaf node, the first authentication operation based on the identity authentication request, to obtain the first authentication information corresponding to the trusted leaf node comprises:
generating, by the trusted leaf node, a first authentication code by using a symmetric key of a quoting enclave, and sending the first authentication code to the quoting enclave, so that the quoting enclave verifies the first authentication code;
receiving, by the trusted leaf node, a first quoting structure body and a first signature that are fed back by the quoting enclave, wherein the first quoting structure body and the first signature are obtained after the quoting enclave successfully verifies the first authentication code; and
determining the first quoting structure body and the first signature as the first authentication information.

6. The method according to claim 5, wherein receiving, by the trusted leaf node, the first quoting structure body and the first signature that are fed back by the quoting enclave comprises:
receiving, by the trusted leaf node, the first quoting structure body and the first signature that are obtained after the quoting enclave verifies, based on the symmetric key, whether the trusted leaf node runs on a same cloud computing platform and the quoting enclave is encapsulated.

7. The method according to claim 4, wherein performing, by the trusted relay node, the second authentication operation based on the identity authentication request, to obtain the second authentication information corresponding to the trusted relay node comprises:
sending, by the trusted relay node, a first certification request to a third-party certification device to obtain the first certification result, wherein the first certification request is used to certify the first authentication information of the trusted leaf node;
in response to, based on the first certification result, the first authentication information of the trusted leaf node passing certification, generating, by the trusted relay node, a second authentication code by using a symmetric key of a quoting enclave, and sending the second authentication code and the first certification information tree to the quoting enclave, so that the quoting enclave verifies the second authentication code;
receiving, by the trusted relay node, a second quoting structure body and a second signature that are fed back by the quoting enclave, wherein the second quoting structure body and the second signature are obtained after the quoting enclave successfully verifies the second authentication code; and
determining the second quoting structure body and the second signature as the second authentication information.

8. The method according to claim 7, wherein receiving, by the trusted relay node, the second quoting structure body and the second signature that are fed back by the quoting enclave comprises:
receiving, by the trusted relay node, the second quoting structure body and the second signature that are obtained after the quoting enclave verifies, based on the symmetric key, whether the trusted relay node runs on a same cloud computing platform and the quoting enclave is encapsulated.

9. The method according to claim 4, wherein performing, by the trusted root node, the third authentication operation based on the identity authentication request, to obtain the third authentication information corresponding to the trusted root node comprises:
sending, by the trusted root node, a second certification request to a third-party certification device to obtain the second certification result, wherein the second certification request is used to certify the second authentication information of the trusted relay node;
in response to, based on the second certification result, the second authentication information of the trusted relay node passing certification, generating, by the trusted root node, a third authentication code by using a symmetric key of a quoting enclave, and sending the third authentication code and the second certification information tree to the quoting enclave, so that the quoting enclave verifies the third authentication code;
receiving, by the trusted root node, a third quoting structure body and a third signature that are fed back by the quoting enclave, wherein the third quoting structure body and the third signature are obtained after the quoting enclave successfully verifies the third authentication code; and
determining the third quoting structure body and the third signature as the third authentication information.

10. The method according to claim 9, wherein receiving, by the trusted root node, the third quoting structure body and the third signature that are fed back by the quoting enclave comprises:
receiving, by the trusted root node, the third quoting structure body and the third signature that are obtained after the quoting enclave verifies, based on the symmetric key, whether the trusted root node runs on a same cloud computing platform and the quoting enclave is encapsulated.

11. The method according to claim 2, wherein after receiving the target certification information tree sent by the user device, and storing the target certification information tree to each trusted node, the method further comprises:
receiving a distributed computing request sent by the user device, wherein the distributed computing request carries target data sent by the user device and a distribution manner corresponding to the target data;
sending, by using the trusted root node, the target data to the trusted relay node according to the distribution manner, and sending, by the trusted relay node, the target data to the trusted leaf node according to the distribution manner;
performing, by the trusted leaf node, the distributed computing on the target data to obtain a first computing result, and sending the first computing result to the trusted relay node;
summarizing, by the trusted relay node, the first computing result to obtain a second computing result, and sending the second computing result to the trusted root node; and
summarizing, by the trusted root node, the second computing result to obtain a third computing result, and sending the third computing result to the user device.

12. The method according to claim 11, wherein the distributed computing request is generated in a following manner;
obtaining a temporary key corresponding to the user device, wherein the temporary key comprises encrypted data and code data; and
performing, by the trusted root node, an encryption operation on the encrypted data and the code data by using the first key to obtain the target data and the distributed computing request that correspond to the encryption operation.

13. The method according to claim 12, wherein sending, by the trusted root node, the target data to the trusted relay node according to the distribution manner comprises:
decrypting, by the trusted root node, the temporary key by using the first key to obtain a first temporary key, encrypting the first temporary key by using the second key, and sending the first temporary key to the trusted relay node according to the distribution manner.

14. The method according to claim 13, wherein sending, by the trusted relay node, the target data to the trusted leaf node according to the distribution manner comprises:
decrypting, by the trusted relay node, a second temporary key by using the second key, encrypting the second temporary key by using the third key, and sending the second temporary key to the trusted leaf node according to the distribution manner.

15. The method according to claim 14, wherein performing, by the trusted leaf node, the distributed computing on the target data to obtain the first computing result, and sending the first computing result to the trusted relay node comprises: decrypting, by the trusted leaf node, the second temporary key by using the third key to obtain code data of the second temporary key; and
performing, by the trusted leaf node, the distributed computing on the target data based on the code data to obtain the first computing result, encrypting the first computing result by using the third key, and sending the encrypted first computing result to the trusted relay node.

16. The method according to claim 15, wherein summarizing, by the trusted relay node, the first computing result to obtain the second computing result, and sending the second computing result to the trusted root node comprises:
decrypting, by the trusted relay node, the first computing result by using the third key, and summarizing the decrypted first computing result to obtain the second computing result; and
encrypting, by the trusted relay node, the second computing result by using the second key, and sending the encrypted second computing result to the trusted root node.

17. The method according to claim 16, wherein summarizing, by the trusted root node, the second computing result to obtain the third computing result, and sending the third computing result to the user device comprises:
decrypting, by the trusted root node, the second computing result by using the second key, and summarizing the decrypted second computing result to obtain the third computing result; and
encrypting, by the trusted root node, the third computing result by using the first key, and sending the encrypted third computing result to the user device, so that the user device decrypts the third computing result by using the first key to obtain a target computing result of the distributed computing.

18. (canceled)

19. A non-transitory readable storage medium, wherein the non-transitory readable storage medium comprises a stored program, and when the stored program runs, the steps of the method according to claim 1 are executed.

20. An electronic device, comprising a processor, a communication interface, a memory, and a communication bus, wherein the processor, the communication interface, and the memory communicate with each other through the communication bus;
the memory is configured to store a computer program; and
the processor is configured to run the computer program stored on the memory to execute the steps of the method according to claim 1.

21. The method according to claim 5, wherein performing, by the trusted leaf node, a first authentication operation based on the identity authentication request further comprises:
generating, by the trusted leaf node, a media access control (MAC) address by using the symmetric key of the quoting enclave.
